(19) United States
(12) Patent Application Publication
(10) Pub. No.: US 2017/0203623 A1
(43) Pub. Date: Jul. 20, 2017

(54) WHEEL SUSPENSION DEVICE

(71) Applicant: VOLVO CONSTRUCTION EQUIPMENT AB, Eskilstuna (SE)

(72) Inventors: Henric PETTERSSON, Luleå (SE); Tobias SÖDERBERG, Luleå (SE); Amin QAADOUN, Älvsbyn (SE)

(73) Assignee: VOLVO CONSTRUCTION EQUIPMENT AB, Eskilstuna (SE)

(21) Appl. No.: 15/326,488

(22) PCT Filed: Jul. 16, 2014
(86) PCT No.: PCT/SE2014/000098

§ 371 Date: Jan. 15, 2017

(51) Int. Cl. B60G 5/02; B60G 7/02; B60G 3/14

(52) U.S. Cl. CPC B60G 5/02; B60G 3/145; B60G 7/02; B60G 13/08

(57) ABSTRACT

A wheel suspension device for a vehicle includes a beam connectable to a frame of the vehicle and a wheel spindle for receiving a wheel, wherein the wheel spindle has an axis coinciding with the intended wheel rotation axis, and the beam has a pivot axis for pivoting the beam relative to the frame about the pivot axis. The wheel spindle is arranged on the beam for enabling the wheel to move up and down relative to the frame by pivot motion of the beam and the beam pivot axis and the wheel spindle axis are angled relative to each other.

### BACKGROUND AND SUMMARY

The invention relates to a wheel suspension device for a vehicle having a frame, where the wheel is allowed to move up and down relative to the frame by means of pivot motion.

The invention can be applied on different types of vehicle, in particular working machines such as articulated haulers.

Although the invention will be described with respect to a wheel suspension device for an articulated hauler, the application of the invention is not restricted to this particular application, but may also be used in other vehicles, for instance other types of work machine such as a wheel loader, a dump truck or any other type of construction equipment.

A working machine is usually provided with a bucket, container or other type of implement for digging, lifting, carrying and/or transporting a load.

For example, an articulated hauler has a dump body for transporting a load. This type of working machine has also a bogie for suspension of the rear axles of the machine. Such a bogie solution allows the wheels to be moved up and down in accordance with the terrain characteristics. The bogie solution is designed such that when a first axle of the bogie moves upwards, the second axle moves downwards, and vice versa.

The allowed displacement of the wheel/wheel axle relative to the frame in the vertical direction is however limited due to the presence of other components on the vehicle. The position and width of the dump body relative to the axle track width (distance between a wheel on the left side and a wheel on the right side) of the articulated hauler, will often limit the distance the wheel theoretically could be moved in the vertical direction. The size of the dump body is designed with the aim of fulfilling the demands on load capacity.

Whilst a conventional bogie solution is robust and has been proven to exhibit good performance, there is still a need of further reducing slip and improving the terrainability of this type of working machines.

It is desirable to provide a wheel suspension device for a vehicle, by which device the performance of the vehicle can be improved.

The invention is based, according to an aspect thereof, on the insight that by the provision of a wheel suspension device having a beam connectable to a frame of the vehicle and a wheel spindle for receiving a wheel, the wheel spindle having an axis coinciding with the intended wheel rotation axis, the beam having a pivot axis for pivoting the beam relative to the frame about the pivot axis, the wheel spindle being arranged on the beam for enabling the wheel to move up and down relative to the frame by means of pivot motion of the beam, and wherein the beam pivot axis and the wheel spindle axis are angled relative to each other, the wheel suspension device can be installed such that beam pivot axis is angled relative to a horizontal plane while the wheel spindle axis being substantially horizontal. Thereby, when the wheel is moved upwardly by pivoting the beam relative to the frame, an outward lateral movement of the wheel can be obtained, and thus the allowed vertical displacement of the wheel can be increased without interfering with other vehicle parts. Such an increased vertical wheel travel distance will prevent slip and improve the terminability of the vehicle.

According to one embodiment of the wheel suspension device, the beam and the wheel spindle are pivotally connected to each other for pivoting relative to each other about a further pivot axis. Preferably, the further pivot axis is substantially in parallel with the beam pivot axis and displaced relative to the beam pivot axis. Hereby, the wheel can be steered by pivoting the wheel spindle relative to the beam about the further pivot axis. This in turn will decrease the tire wear and improve terrainability and manoeuvring of the vehicle. The pivot motion about the further pivot axis can be performed by a motor, such as a hydraulic or electric motor, or by one or more hydraulic cylinders, and any other auxiliary equipment such as gears, levers, etc.

Furthermore, by pivoting the wheel spindle relative to the beam, it is also possible to adjust for the tilt angle of the wheel that arises due to the fact that the wheel has been pivoted relative to the frame about the angled beam pivot axis. In other words; when the wheel is moved upwards and thereby also in the lateral direction, a tilt angle of the vehicle can be prevented or at least counteracted by pivoting the wheel spindle relative to the beam about the further pivot axis.

According to a second aspect, the invention relates to a vehicle comprising a frame and a wheel suspension device attached to the frame, the wheel suspension device comprising a beam provided with a wheel spindle for carrying a wheel, the beam being pivotally connected to the frame about a pivot axis for pivoting the beam relative to the frame, thereby enabling the wheel to move up and down relative to the frame, wherein the beam pivot axis is angled relative to a horizontal axis perpendicular to the longitudinal direction of the vehicle, when looked in the longitudinal direction of the vehicle, and the beam pivot axis direction is defined by one downwardly directed vertical extension component and one horizontal extension component which is perpendicular to the longitudinal direction of the vehicle, such that the beam pivot axis is directed obliquely downwards in a direction from the frame towards the wheel.

Effects, and advantages of the second aspect of the present invention are largely analogous to those described above in relation to the first aspect of the present invention.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a lateral view illustrating a vehicle according to the invention,

FIG. 2a shows in a cross section view one embodiment of the wheel suspension device according to the invention,

FIG. 2b shows in a perspective view a further embodiment of the wheel suspension device according to the invention,

FIG. 3a is a side view illustrating the bogie wheels of the vehicle in FIG. 1, where a wheel suspension device according to the invention is implemented,

FIG. 3b is a bottom view illustrating the bogie wheels in FIG. 3a, and

FIG. 4 is a side view illustrating a further embodiment of the wheel suspension device according to the invention.

### DETAILED DESCRIPTION

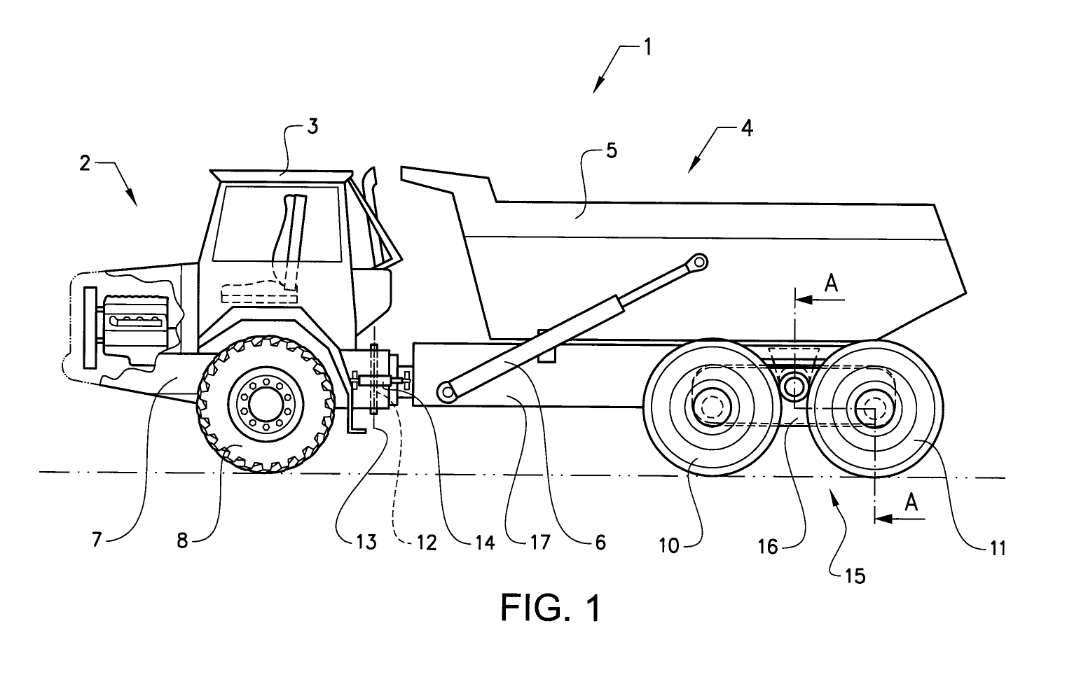

FIG. 1 is an illustration of a vehicle 1 according to the invention. The articulated hauler illustrated is an example of a working tnachine where the invention can be applied. The articulated hauler has a front section 2 with a cab 3 for a driver and a rear section 4 with a platform having a dump body 5 or container arranged thereon for receiving load. The dump body 5 is preferably pivotally connected to the rear section and tiltable by means of a pair of tilting cylinders 6, for example hydraulic cylinders. The front section has a front frame 7 and a pair of wheels 8 suspended from the front frame 7. The rear section 4 has a rear flume 17 and two pair of wheels 10, 11 suspended from the rear frame 17. The working machine is frame-steered, i.e. there is a pivot joint 12 connecting the front section 2 and the rear section 4 of the working machine 1. The front section and the rear section are pivotally connected to each other for pivoting about a substantially vertical pivot axis 13.

The working machine preferably comprises a hydraulic system having two hydraulic cylinders 14, steering cylinders, arranged on opposite sides of the working machine for turning the working machine by means of relative movement of the front section 2 and the 35 rear section 4.

The working machine can further comprise a second pivot joint connecting the front section 2 and the rear section 4 of the working machine for allowing the front section and the rear section to pivot relative to each other about a substantially horizontal pivot axis extending in the longitudinal direction of the working machine.

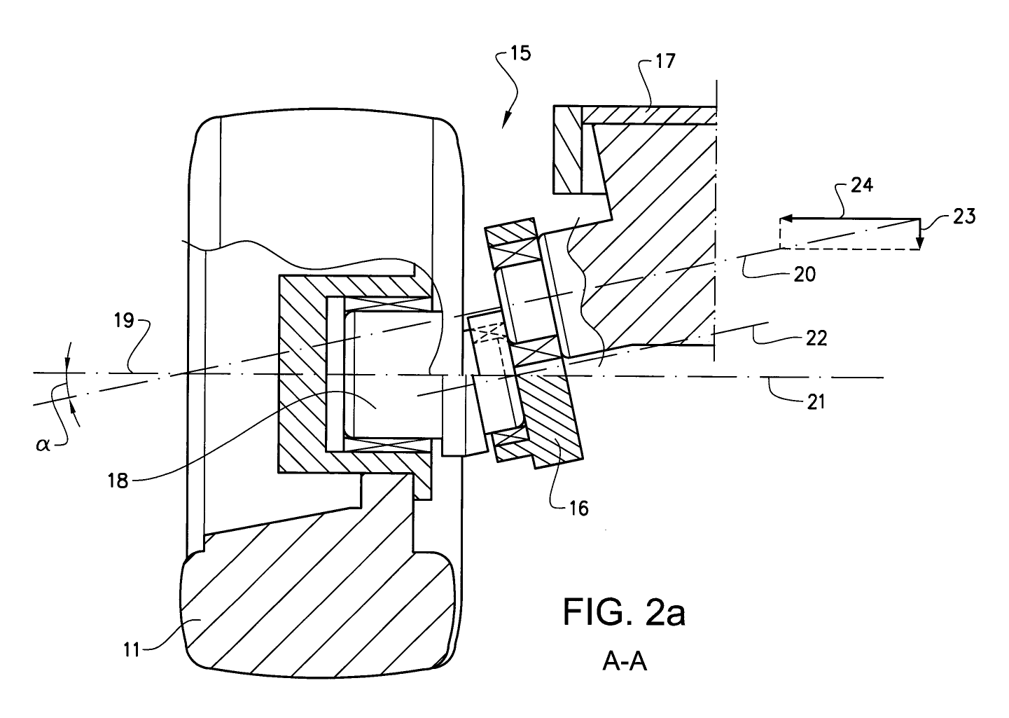

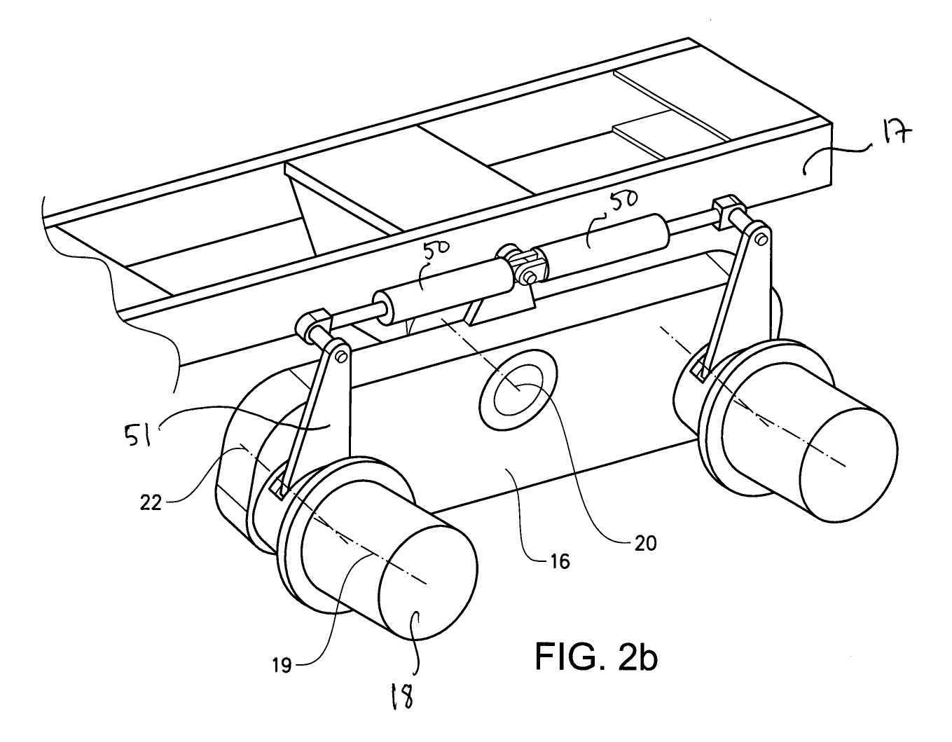

In FIG. 1 one example embodiment of the wheel suspension device 15 according to the invention is schematically illustrated. Details of the wheel suspension device 15 appear from the cross section view in FIG. 2a. Same reference numerals used in different figures will indicate same or similar components.

The wheel suspension device 15 has a beam 16 connectable to a frame 17 of the vehicle 1 and a wheel spindle 18 for receiving a wheel 11. The wheel spindle 18 has an axis 19 coinciding with the intended wheel rotation axis, and the beam 16 has a pivot axis 20 for pivoting the beam 16 relative to the frame 17 about the pivot axis 20. The wheel spindle 18 is arranged on the beam 16 for enabling the wheel 11 to move up and down relative to the frame 17 by means of pivot motion of the beam 16. Furthermore, the beam pivot axis 20 and the wheel spindle axis 19 are angled relative to each other for achieving an outward lateral movement of the wheel 11 when the wheel is moved upwardly by pivoting the beam 16 relative to the frame 17. The angle a between the beam pivot axis 20 and the wheel spindle axis 19 enables the beam pivot axis 20 to be angled relative to the horizontal plane 21 while keeping the wheel spindle axis 19 in another direction, such as a substantially horizontal direction, when the wheel suspension device 15 is attached to the frame 17 of the vehicle 1. An angled beam pivot axis 20 will in turn cause the wheel 11 to move also in the lateral direction when the beam 16 be pivoted about the beam pivot axis 20. The angle a between the beam pivot axis 20 and the wheel spindle axis 19 is suitably in the interval 0<a<30°, preferably 2°<a<25°, and more preferably in the interval 5°<a<20°. For example in articulated hauler applications, it has been found out that the angle a is suitably in the interval 5-15°, and the angle a is preferably approximately 10°.

Thus, the wheel suspension device 15 is preferably adapted to be installed in the vehicle 1 such that the beam pivot axis 20 is angled relative to a horizontal axis 21 perpendicular to the longitudinal direction of the vehicle 1, when looked in the longitudinal direction of the vehicle. The beam pivot axis direction is then defined by one downwardly directed vertical extension component 23 and one horizontal extension component 24 which is perpendicular to the longitudinal direction of the vehicle, such that the beam pivot axis 20 is directed obliquely downwards in a direction from the frame towards the wheel.

In addition, the beam pivot axis 20 and the wheel spindle axis 19 are preferably displaced relative each other in the vertical direction such that the wheel spindle axis 19 is arranged below the beam pivot axis 20, when comparing the bearing positions.

By the expression that the wheel spindle axis 19 is substantially horizontal is meant a condition when the vehicle standing still on a level of the ground. Of course, if the vehicle is tilted the wheel spindle axis 19 will also be tilted with the same angle. In addition, the direction of the wheel spindle axis 19 will vary for different directions of the beam 16.

In FIG. 2a the beam 16 has a neutral direction with respect to pivoting about the beam pivot axis 20, where the beam 16 can be substantially horizontal pointing in the longitudinal direction of the vehicle as illustrated in FIG. 1, from which direction the beam 16 can be pivoted clockwise or anticlockwise. If the beam 16 is pivoted in the clockwise direction, i.e. the rear bogie wheel 11 is lowered, the wheel 11 will also move laterally towards the frame 17 and the wheel spindle axis 19 will not be exactly horizontal. If the beam 16 is pivoted anticlockwise, i.e. the rear bogie wheel 11 is raised, the wheel 11 will also move laterally away from the frame 17 and the wheel spindle axis 19 will not be exactly horizontal. The wheel suspension device 15 is preferably adapted to be installed such that the wheel spindle axis 19 is substantially horizontal when the beam 16 is brought into such a neutral horizontal direction.

The wheel 11 is arranged on the beam 16 at a distance from the beam pivot axis 20 to create a lever/pivot arm (in the horizontal longitudinal direction of the vehicle). This can be arranged as in the illustrated example embodiment where a bogie system having a front bogie wheel 10 and a rear bogie wheel 11 is depicted, but it is also possible to apply the invention in a system with another number of wheels arranged on the beam, such as for example one single wheel or one single axle. The wheel/wheels can be individually suspended on one side of the vehicle relative to the corresponding wheel/wheels on the other side of the vehicle, or in another embodiment a wheel on the left side and a corresponding wheel on the right side may be connected to each other for moving together. Such a connection can be for example a mechanical or hydraulic connection.

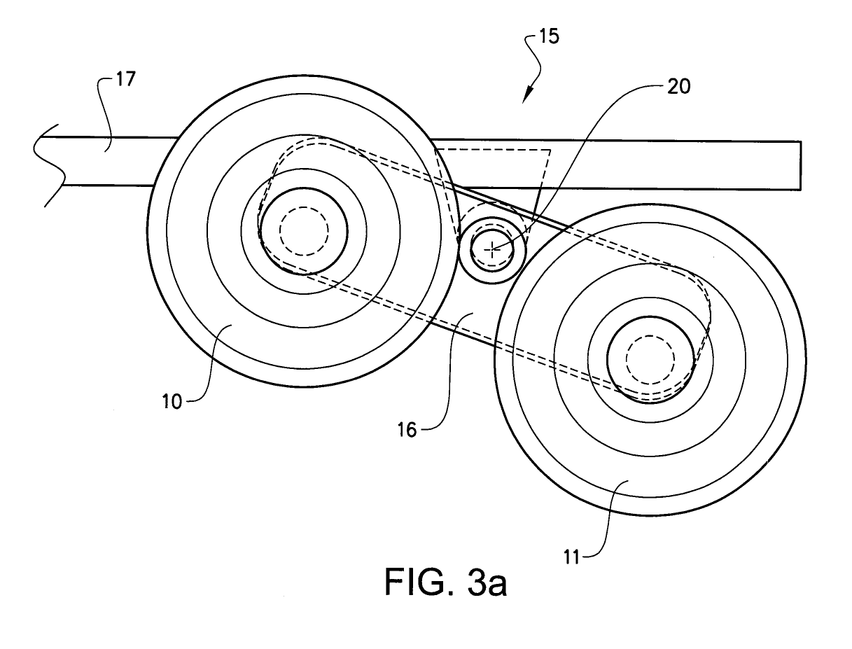

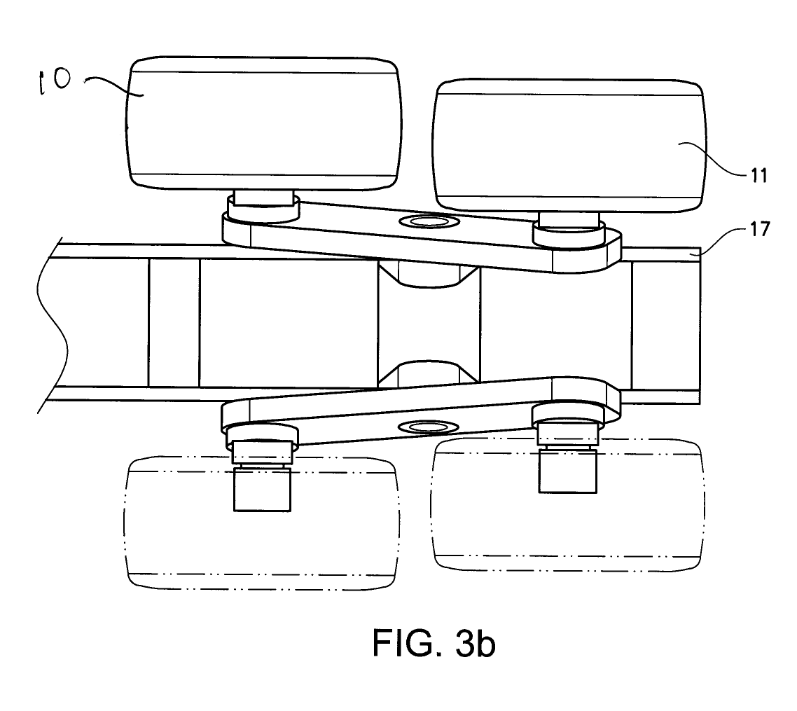

FIG. 3a is a side view of the wheel suspension device 15 where the front wheel 10 of the bogie has been moved upwardly from the bogie beam 16 horizontal position, whereas the rear bogie wheel 11 has been moved downwardly from the bogie beam 16 horizontal position correspondingly. The bogie wheels are also moved laterally due to the angled pivot axis 20 of the beam 16. As the bogie is illustrated in FIG. 3a, the front bogie wheel 10 is positioned at a greater distance from the frame 17 in the horizontal direction, as compared to the bogie beam horizontal position illustrated in FIG. 1, and the rear bogie wheel 11 is positioned at a smaller distance from the frame 17, as compared to the bogie beam horizontal position illustrated in FIG. 1. This appears also from FIG. 3b that is a bottom view illustrating the bogie wheels 10, 11 in FIG. 3a.

As also indicated in FIG. 2a, optionally, the beam 16 and the wheel spindle 18 can be pivotally connected to each other for pivoting relative to each other about a further pivot axis 22. The further pivot axis 22 is preferably substantially in parallel with the beam pivot axis 20 and displaced downwardly relative to the beam pivot axis 20. In such a case the wheel spindle 18 has to be connected to the beam 16 or the frame for pivoting the wheel spindle 18 about the further pivot axis 22 and holding the wheel spindle 18 at the desired pivot position. The pivot motion about the further pivot axis 22 can be performed by a motor, such as a hydraulic or electric motor, or by one or more hydraulic cylinders, and any other auxiliary equipment such as gears, levers, etc. In FIG. 2b one embodiment having such equipment is illustrated. One hydraulic cylinder 50 is arranged for each wheel. The hydraulic cylinder 50 is at a first end thereof connected to a lever arm 51 which in turn is connected to the wheel spindle 18. By activation of the hydraulic cylinder 50 the beam 16 and wheel spindle 18 can be pivoted relative to each other about the further pivot axis 22. The hydraulic cylinder 50 is at a second end thereof connected to the beam 16. In another embodiment the second end of the hydraulic cylinder could be connected directly to the frame instead of the beam. The hydraulic cylinder 50 can be arranged outside the beam 16 as illustrated or inside the beam if the beam is designed as a box.

Furthermore, with reference to FIG. 2a the pivot axis 20 described herein for pivoting the beam 16 relative to the frame 17, and the further pivot axis 22 for pivoting the wheel spindle 18 relative to the beam 16 where so is appropriate, can be achieved by using different kind of bearings, such as roller or sliding bearings that are well known to the person skilled in the art.

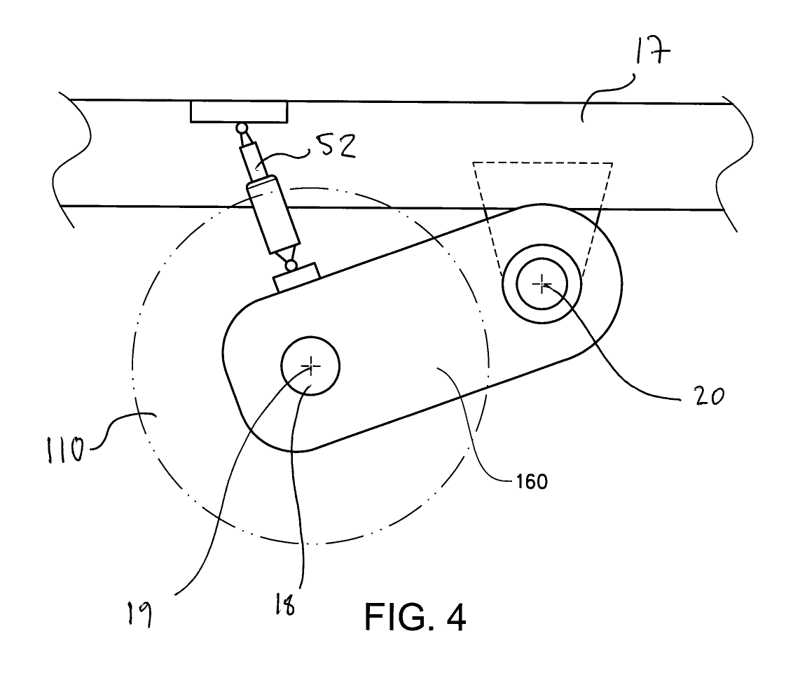

In FIG. 4 a further embodiment of the wheel suspension device according to the invention is illustrated. In this embodiment there is a single wheel 110 arranged on the beam 160. The pivot axis 20 for pivoting the beam 160 relative to the frame 17, and the further pivot axis (not shown in FIG. 4) for pivoting the wheel spindle 18 relative to the beam 160, if any such further pivot axis, can be achieved in the same way as already described hereinabove with reference to previous figures. Also in this embodiment the beam pivot axis 20 and the wheel spindle axis 19 are preferably displaced relative each other in the horizontal and vertical direction such that the wheel spindle axis 19 is arranged below the beam pivot axis 20 when the beam 16 is brought into a neutral position. However, in this case the neutral position of the beam does not mean that the beam 160 extends in the horizontal direction. The beam 160 is also suitably connected to the frame 17 by means of any suitable suspension element 52, such as a spring, hydraulic cylinder and/or rubber element or similar.

The features described with reference to the wheel suspension device 15 can also be applied to the vehicle 1 according to the invention and the advantages associated with the wheel suspension device are analogous to the vehicle.

With reference to FIG. 1 and remaining figures herein, the vehicle 1 according to the invention comprises a frame 17 and a wheel suspension device 15 attached to the frame 17. The wheel suspension device 15 comprises a beam 16 provided with a wheel spindle 18 for carrying a wheel 11, and the beam 16 is pivotally connected to the finme 17 about a pivot axis 20 for pivoting the beam 16 relative to the flame 17, thereby enabling the wheel 11 to move up and down relative to the frame 17. The beam pivot axis 20 is angled relative to a horizontal axis 21 perpendicular to the longitudinal direction of the vehicle, when looked in the longitudinal direction of the vehicle. The beam pivot axis 20 direction is defined by one downwardly directed vertical extension component 23 and one horizontal extension component 24 which is perpendicular to the longitudinal direction of the vehicle, such that the beam pivot axis 20 is directed obliquely downwards in a direction from the frame towards the wheel. The angle a between the beam pivot axis 20 and the horizontal axis 21 is suitably in the interval 0<a<30°, preferably 2°<a<25°, and more preferably in the interval 5°<a<20°. For articulated haulers, for instance, it has been found out that the angle a is suitably in the interval 5-15°, and the angle a is preferably approximately 10°.

It is to be understood that the present invention is not limited to the embodiments described above and illustrated in the drawings; rather, the skilled person will recognize that many changes and modifications may be made within, the scope of the appended claims. For example, with respect to all embodiments described herein, the wheels for which the wheel suspension device according to the invention is applied can be driven or non-driven wheels. In case of driven wheels, electric or hydraulic hub motors are preferably used.

1. A wheel suspension device for a vehicle, comprising a beam connectable to a frame of the vehicle and a wheel spindle for receiving a wheel, the wheel spindle having an axis coinciding with the intended wheel rotation axis, the beam having a pivot axis for pivoting the beam relative to the frame about the pivot axis, the wheel spindle being arranged on the beam for enabling the wheel to move up and down relative to the frame by means of pivot motion of the beam, wherein the beam pivot axis and the wheel spindle axis are angled relative to each other, wherein the wheel suspension device is adapted to be installed in the vehicle such that the beam pivot axis is angled relative to a horizontal axis perpendicular to the longitudinal direction of the vehicle, when looked in the longitudinal direction of the vehicle, the beam pivot axis direction being defined by one downwardly directed vertical extension component and one horizontal extension component which is perpendicular to the longitudinal direction of the vehicle, such that the beam pivot axis is directed obliquely downwards in a direction from the frame towards the wheel such that when the wheel is moved upwardly by pivoting the beam relative to the frame, an outward lateral movement of the wheel can be obtained.

2. A wheel suspension device according to claim 1, wherein the angle (a) between the beam pivot axis and the wheel spindle axis is in the interval 0<a<30°.

3. A wheel suspension device according to claim 1, wherein the angle (a) between the beam pivot axis and the wheel spindle axis Is In the interval 2°<a<25°.

4. A wheel suspension device according to claim 1, wherein the angle (a) between the beam pivot axis and the wheel spindle axis is in the in 5°<a<20°.

5. A wheel suspension device according to claim 1, wherein the wheel suspension device is adapted to be installed such that the wheel spindle axis Is substantially horizontal when the beam has a neutral horizontal direction.

6. A wheel suspension device according to claim 1, wherein the beam and the wheel spindle are pivotally connected to each other for pivoting relative to each other about a further pivot axis.

7. A wheel suspension device according to claim 6, wherein the further pivot axis is substantially in parallel with the beam pivots and displaced relative to the beam pivot axis.

8. A wheel suspension device according to claim 1, wherein the beam is a bogie beam provided with one the wheel spindle on both sides of the beam pivot axis for receiving a front bogie wheel and a rear bogie wheel, respectively.

9. A vehicle comprising a frame and a wheel suspension device attached to the frame, the wheel suspension device comprising a beam provided with a wheel spindle for carrying a wheel, the beam being pivotally connected to the frame about a pivot axis for pivoting the beam relative to the frame, thereby enabling the wheel to move up and down relative to the frame, wherein the beam pivot axis is angled relative to a horizontal axis perpendicular to the longitudinal direction of the vehicle, when looked in the longitudinal direction of the vehicle, the beam pivot axis direction being defined by one downwardly directed vertical extension component and one horizontal extension component which is perpendicular to the longitudinal direction of the vehicle, such that the beam pivot axis is directed obliquely downwards In a direction from the frame towards the wheel such that when the wheel is moved upwardly by pivoting the beam relative to the frame, an outward lateral movement of the wheel can be obtained.

10. A vehicle according to claim 9, wherein the angle (a) between the beam pivot axis and the horizontal axis is in the interval 0<a<30°.

11. A vehicle according to claim 9, wherein the angle (a) between the beam pivot axis and the horizontal axis is in the interval 2°<a<25°.

12. A vehicle according to claim 9, wherein the angle (a) between the beam pivot axis and the horizontal axis is in the Interval 5°<a<20°.

13. A vehicle according to claim 9, wherein the beam and the wheel spindle are pivotally connected to each other for pivoting relative to each other about a further pivot axis.

14. A vehicle according to claim 13, wherein the further pivot axis is substantially in parallel with the beam pivot axis and displaced relative to the beam pivot axis.

15. A vehicle according to claim 9, wherein the beam is a bogie beam provided with one the wheel spindle on both sides of the beam pivot axis for receiving a front bogie wheel and a rear bogie wheel, respectively.

16. A vehicle according to claim 9, wherein the vehicle is a working machine.
